(19) United States
(12) Patent Application Publication
(10) Pub. No.: US 2019/0299941 A1
(43) Pub. Date: Oct. 3, 2019

(54) VEHICLE TREATMENT BRUSH AND VEHICLE TREATMENT INSTALLATION

(71) Applicant: Alfred Kärcher SE & Co. KG, Winnenden (DE)

(72) Inventor: Bernd HABERL, Weissach im Tal (DE)

(21) Appl. No.: 16/448,136

(22) Filed: Jun. 21, 2019

Related U.S. Application Data
(63) Continuation of application No. PCT/EP2016/082362, filed on Dec. 22, 2016.

(51) Int. Cl. B60S 3/06; A46B 7/10; A46B 13/00; B08B 1/00

(52) U.S. Cl. CPC B60S 3/063; A46B 7/10; A46B 2200/3046; B08B 1/002; A46B 13/003

(57) ABSTRACT

A vehicle treatment brush is provided for washing and/or polishing purposes in a vehicle treatment installation, including a support part having a longitudinal extent and defining a pivotal axis, a plurality of brush segments arranged axially next to each other and each including cleaning elements, and a drive device, wherein at least one brush segment includes a pivoting device with a rotary body on which the cleaning elements of the brush segment are indirectly or directly held and which is in operative connection with the drive device for driving the rotary body about a rotational axis of the brush segment that is different from the pivotal axis.

### CROSS-REFERENCE TO RELATED APPLICATIONS

This application is a continuation patent application of international application number PCT/EP2016/082362, filed on Dec. 22, 2016 which is incorporated herein by reference in its entirety and for all purposes.

### FIELD OF THE INVENTION

The present invention relates to a vehicle treatment brush for washing and/or polishing purposes in a vehicle treatment installation, comprising a support part having a longitudinal extent and defining a pivotal axis, a plurality of brush segments arranged axially next to each other and each comprising cleaning elements, and a drive device, wherein at least one brush segment comprises a pivoting device with a rotary body on which the cleaning elements of the brush segment are indirectly or directly held and which is in operative connection with the drive device for driving the rotary body about a rotational axis of the brush segment that is different from the pivotal axis, wherein the rotary body is pivotable about the pivotal axis relative to the support part by way of the pivoting device, wherein the brush segment comprises at least one restoring device with a restoring element, against the action of which the pivoting device is pivotable in a pivot direction relative to the support part.

The vehicle treatment brush may be used for treating lateral vehicle regions or as a “roof” treatment brush with which vehicle regions located on an upper side and in particular the roof may be treated.

The present invention also relates to a vehicle treatment installation. The vehicle treatment installation may be a gantry-type installation in which a portal provided with a vehicle treatment brush is moved relative to a stationary vehicle. Alternatively, the vehicle treatment installation may be a conveying treatment installation in which the vehicle is transported relative to a vehicle treatment brush by means of a conveying apparatus.

### BACKGROUND OF THE INVENTION

In practice, the problem is that vehicles have different and, in particular, irregular contours and that a cleaning of equal quality of vehicles with different contours poses difficulty. For example, sports cars have a flat, often strongly convex contour on the side, sedans a mid-high, trapezoidal contour, and minivans and minibuses a more rectangular contour. It is known to tilt vehicle treatment brushes relative to the vertical to adapt to the vehicle contour, the cleaning result thereby being able to be improved. However, the multiplicity of design variants allows for only an average improvement in this way only.

EP 0 012 683 proposes to equip a drive shaft of the vehicle treatment brush with a joint, such that two sections of the drive shaft aligned at an angle to each other are present. However, it is disadvantageous that washing elements are omitted in the region of the joint and the vehicle is inadequately cleaned at this location. It is also necessary to mount the shaft on both end sides in order to provide and maintain the angling, which requires a significant material and production expenditure.

A further vehicle treatment brush in EP 0 808 753 A1 comprises a hollow shaft which is rotatably mounted on a core arranged in the interior. The core may be angled at a joint. Different segments of the hollow shaft are coupled by way of face-side tooth arrangements. The vehicle treatment brush has the disadvantage of a complex, difficult to manufacture construction. In addition, an adaptation to different vehicle contours is possible only to a limited extent.

Other proposals for improving the cleaning result address the cleaning elements of the vehicle treatment brush. For example, it is proposed in DE 10 2006 017 999 A1 that the cleaning elements in the rotating state of the vehicle treatment brush form a concave contour by way of the free ends thereof, which contour corresponds approximately to the convex contour of vehicles. The production of this vehicle treatment brush is connected with high costs, because various cleaning elements need to be provided and mounted for different axial sections. In addition, merely an adaptation to an “average” vehicle contour, so to speak, is possible. Limitations become apparent especially in the treatment of flat vehicles such as sports cars and tall vehicles like minibuses.

Further approaches consist of dividing the vehicle treatment brush axially into different brush segments. The brush segments have hollow-cylindrical rotary bodies which are rotated about the respective axis thereof by way of a drive device and may be pivoted relative to an eccentrically arranged shaft driving them. A vehicle treatment brush of that kind is described, e.g., in DE 27 33 091. This proves in practice, however, to be unfit for practice due to a friction roller drive which functions unreliably as a result of ingress of dirt or cleaning liquid. However, a vehicle treatment brush described in the not previously published application DE 10 2015 111 023 of the same applicant has proven itself. In this case, the rotary bodies are able to be driven by way of a toothed gearing transmission. An impairment of the drive of the rotary body by dirt or cleaning liquid may thereby be avoided to the greatest extent possible, because a housing-like coupling of the drive is present. The vehicle treatment brush described in DE 10 2015 111 023 proves itself in practice.

An object underlying the present invention is to provide a vehicle treatment brush and a vehicle treatment installation with a vehicle treatment brush, wherein an adaptation to the contour of the vehicle may be achieved with the vehicle treatment brush in order to achieve a good cleaning result.

### SUMMARY OF THE INVENTION

In a first aspect of the invention, a vehicle treatment brush for washing and/or polishing purposes in a vehicle treatment installation is provided, comprising a support part having a longitudinal extent and defining a pivotal axis, a plurality of brush segments arranged axially next to each other and each comprising cleaning elements, and a drive device. At least one brush segment comprises a pivoting device with a rotary body on which the cleaning elements of the brush segment are indirectly or directly held and which is in operative connection with the drive device for driving the rotary body about a rotational axis of the brush segment that is different from the pivotal axis. The rotary body is pivotable about the pivot axis relative to the support part by way of the pivoting device. The brush segment comprises at least one restoring device with a restoring element, against the action of which the pivoting device is pivotable relative to the support part in a pivot direction. The restoring element comprises or forms a torsional spring which couples to the pivoting device on the one hand and to a stationary holding element on the other hand for pivoting the pivoting device and the holding element relative to each other.

In a second aspect of the invention, a vehicle treatment installation is provided, comprising at least one vehicle treatment brush, in particular washing brush, in accordance with the first aspect of the invention.

### BRIEF DESCRIPTION OF THE DRAWINGS

The foregoing summary and the following description may be better understood in conjunction with the drawing figures, of which:

FIG. 1: shows a schematic view of a vehicle treatment installation in accordance with the invention, configured as a gantry-type washing installation, comprising a vehicle treatment brush, in accordance with the invention, in the form of a vehicle washing brush with a plurality of brush segments during the cleaning of a small vehicle;

FIG. 2: shows the vehicle washing installation from FIG. 1 during the cleaning of a van;

FIG. 3: shows a partial depiction of the vehicle washing brush in perspective view, in which a brush segment is depicted completely and three brush segment are only partially depicted;

FIG. 4: shows the brush segment of the vehicle washing brush from FIG. 3, while hiding some cleaning elements;

FIG. 5: shows the brush segment from FIG. 4 in perspective partial depiction, shown in an exploded view;

FIG. 6: shows a longitudinal sectional view of the brush segment from FIG. 4, while hiding cleaning elements;

FIG. 7: shows a perspective partial view of the brush segment, which shows a restoring device;

FIG. 8: shows a further perspective partial view of the brush segment, which shows a further restoring device;

FIG. 9: shows a plan view of the brush segment in axial direction, wherein cleaning elements contact an (indicated) vehicle for cleaning purposes;

FIG. 10: shows a depiction corresponding to FIG. 9, wherein a distance of the vehicle from a support part of the vehicle washing brush is reduced and a rotary body of the brush segment is pivoted relative to the support part;

FIG. 11: shows a depiction corresponding to FIG. 9, wherein a distance of the vehicle from the support part is reduced further and the rotary body is pivoted further relative to the support part;

FIG. 12: shows a depiction corresponding to FIG. 9, wherein a distance of the vehicle from the support part is reduced even further and the rotary body is pivoted even further relative to the support part;

FIG. 13: shows a plan view of the brush segment in axial direction, wherein cleaning elements contact an (indicated) vehicle for cleaning purposes, wherein a rotary body of the brush segment rotates in reverse direction in relation to the depiction in FIG. 9;

FIG. 14: shows a depiction corresponding to FIG. 13, wherein a distance of the vehicle from a support part of the vehicle washing brush is reduced and the rotary body is pivoted relative to the support part;

FIG. 15: shows a depiction corresponding to FIG. 13, wherein a distance of the vehicle from the support part is reduced further and the rotary body is pivoted further relative to the support part;

FIG. 16: shows a depiction corresponding to FIG. 13, wherein a distance of the vehicle from the support part is reduced even further and the rotary body is pivoted even further relative to the support part;

FIG. 17: shows a depiction corresponding to FIG. 6 in a second preferred embodiment of the vehicle treatment brush in accordance with the invention;

FIG. 18: shows a depiction corresponding to FIG. 7 in the second preferred embodiment;

FIG. 19: shows a depiction corresponding to FIG. 6 in a third preferred embodiment of the vehicle treatment brush in accordance with the invention; and

FIG. 20: shows a depiction corresponding to FIG. 6 in a fourth preferred embodiment of the vehicle treatment brush in accordance with the invention.

### DETAILED DESCRIPTION OF PREFERRED EMBODIMENTS OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a vehicle treatment brush for washing and/or polishing purposes in a vehicle treatment installation, comprising a support part having a longitudinal extent and defining a pivotal axis, a plurality of brush segments arranged axially next to each other and each comprising cleaning elements, and a drive device, wherein at least one brush segment comprises a pivoting device with a rotary body on which the cleaning elements of the brush segment are indirectly or directly held and which is in operative connection with the drive device for driving the rotary body about a rotational axis of the brush segment that is different from the pivotal axis. The rotary body is pivotable about the pivotal axis relative to the support part by way of the pivoting device, wherein the brush segment comprises at least one restoring device with a restoring element, against the action of which the pivoting device is pivotable in a pivot direction relative to the support part.

The vehicle treatment brush in accordance with the invention is divided axially, in relation to the pivotal axis of the support part, into a plurality of brush segments with respective cleaning elements. In the case of at least one brush segment, preferably two or more and particularly preferably all brush segments, a rotary body is provided which can be set into rotation about a rotational axis defined by the same by way of the drive device. The rotational axis differs from the pivotal axis defined by the support part, such that the support part is arranged eccentrically relative to the rotary body in relation to the rotational axis. The rotary body may be pivoted relative to the support part in at least one and preferably two pivot directions by way of the pivoting device. When the vehicle treatment brush approaches the vehicle, the rotational movement of the rotary body may be maintained for cleaning the vehicle, while the rotary body is pivoted by way of the pivoting device in dependence on the vehicle contour, and thereby an optimal adjustment of the distance of the brush segment relative to the vehicle is made possible. The pivoting occurs against the restoring force of the restoring element of at least one restoring device. The restoring element comprises or forms a torsional spring which couples to the pivoting device and a stationary holding element. A torque may be provided by way of the torsional spring, whereby the pivoting device and thus the rotary body may be pivoted relative to the holding element. In particular, the holding element is positioned in fixed spatial relationship to the support part. “Stationary” may in particular presently be understood to the effect that the holding element is non-driven via the drive device and is not moved upon the pivoting movement of the pivoting device. Present on the pivoting device is a point of engagement or stop element which is movable relative to the support part as a result of the pivoting movement of said pivoting device and on which the torsional spring can engage. In the implementation of the vehicle treatment brush in accordance with the invention, the use of a torsional spring as a restoring element has proven in practice to be advantageous. For example, a substantially linear characteristic curve of the restoring element may thereby be provided, in particular if the torsional spring is under pretension. The pivoting may occur steadily and not abruptly in dependence on the vehicle contour. This offers the possibility that the cleaning elements have sufficient, but not excessive contact with the vehicle at all times. As a result, an overall better cleaning result may be achieved.

In an advantageous embodiment of the invention, the torsional spring may be configured as a coil spring.

It is favorable if a core is provided which the torsional spring surrounds. By way of the core, the torsional spring may be reliably held in position and, for example, secured against a tilting moment that may occur when deforming the torsional spring.

It is advantageous if the support part comprises or forms the core. This makes it possible to reliably hold the torsional spring in position by way of the support part. A separate core may be saved. Windings of the torsional spring may preferably be guided with play about the support part in order to allow for a simpler deformation of torsional spring.

The torsional spring is advantageously aligned coaxially to the support part.

The stationary holding element serves as a fixed engagement point for the torsional spring. This does not rule out in the present case, however, that the holding part is directly or indirectly moved, for example in order to enable advancing the vehicle treatment brush to the vehicle.

In an advantageous embodiment of the vehicle treatment brush, the support part forms the holding element. A separate additional holding element may thereby be saved. For example, formed on the support part is at least one receptacle into which the torsional spring is able to engage with an end section. For forming the holding element, the support part is advantageously non-driven, which will be explained below.

In a different kind of advantageous embodiment, the holding element may be secured on the support part, for example by positive and/or force lock.

It is favorable if the torsional spring is arranged within a contour of the rotary body independently of the position of the pivoting device relative to the support part. This may presently be understood in particular as the torsional spring not protruding radially, in relation to the rotational axis, over a contour of the rotary body. This ensures that the torsional spring cannot come into contact with the vehicle surfaces and damage them. A problem of that kind may occur, e.g., in case of the vehicle treatment brush that is described in the document DE 27 330 91 stated at the outset.

The pivoting device is preferably pivotable in the pivot direction relative to the support part commencing from a base position against a pretension of the torsional spring. The torsional spring element has a pretension to transfer the pivoting device into the base position. In practice, the pretension proves to be advantageous, the pivoting device thereby pivoting against the restoring force of the torsional spring from the start. A “wobbling” or “fluttering” of the rotary body in contact with the vehicle is thereby avoided and the cleaning result improved.

The pretension of the torsional spring is preferably variable. The vehicle treatment brush is in this way diversely adaptable. By way of the pretension, it may be adjusted with what force of the rotary body against the vehicle the pivotal movement begins. Vice versa, the contact force of the cleaning elements on the vehicle and/or the pivot angle, for example, may thereby be adjusted. The intensity of the cleaning of the vehicle may thereby be influenced. When using different cleaning elements that differ from each other in their specific friction coefficients, an identical or comparable contact force may be achieved by way of the adjustment of the pretension.

Provision may be made for the holding element to comprise or form a plurality of receptacles into which the torsional spring may selectively engage and thereby may be brought into different tensioned states. This makes it possible in a constructively simple matter to change the pretension of the torsional spring.

In an advantageous embodiment of the vehicle treatment brush, provision may be made for the rotary body to be pivotable in two opposite pivot directions by way of the pivoting device. This proves to be advantageous particularly if the rotary body is able to be driven to rotate in different rotational directions, which is advantageous for the cleaning result. Depending on in which rotational direction the rotary body rotates, a torque may be exerted on the pivoting device by way of the cleaning elements for pivoting in one of the two pivot directions. The advantages already mentioned may thereby be achieved when pivoting the pivoting device both in the one pivot direction and in the other pivot direction.

The pivot angle about which the rotary body is pivotable relative to the support part by way of the pivoting device may be delimited. A maximum pivot angle in each pivot direction is about 180°, for example.

The delimitation of the pivot angle may take place through a stationary stop element against which the pivoting device strikes upon pivoting. Two stop elements may be present when pivoting in both pivot directions, or the stop element may be differently positionable depending on the rotational direction of the rotary body.

In an advantageous embodiment, the pivot angle may be influenced by way of the at least one restoring device of the brush segment.

It is advantageous if the restoring device comprises a stop element for the torsional spring against which the latter strikes in such a way when the pivoting device adopts a base position that in the base position no spring force is exerted on the pivoting device by way of the torsional spring, and if the pivoting device is pivotable in the opposite pivot direction commencing from the base position. With the possibility of pivoting in both directions, as mentioned above, the base position of the pivoting device relative to the support part may be better defined by no restoring force being exerted when the pivoting device adopts the base position. However, the pivoting device may be pivoted in the opposite pivot direction, the torsional spring not being loaded further.

The last mentioned embodiment is used in particular when the brush segment in a preferred embodiment comprises two restoring devices, wherein the rotary body is pivotable by way of the pivoting device in two opposite pivot directions relative to the support part, against the action of a respective restoring element of a restoring device. A pivoting of the rotary body by way of the pivoting device is possible in each of the two pivot directions, against the action of a respective restoring element. A vehicle treatment brush of that kind is suitable particularly if the rotary body, as mentioned, is able to be driven in both rotational directions, wherein a pivoting in one of the two pivot directions is possible in dependence on the rotational direction commencing from the base position.

Optionally, in the case of a vehicle treatment brush of the kind stated at the outset, for establishing an independent invention, provision may preferably be made for the brush segment to comprise two restoring devices, wherein the rotary body is pivotable by way of the pivoting device in two opposite pivot directions relative to the support part, against the action of a respective restoring element of a restoring device.

The pivoting in both pivot directions preferably takes place against the pretension of a respective restoring element.

The restoring devices are preferably configured the same with respect to function.

For example, the restoring devices are arranged axially on opposing sides of the pivoting devices, i.e., in the intended use, in particular above the rotary body and below the rotary body in relation to the pivotal axis.

Preferably both restoring elements are configured as torsional springs which couple to the pivoting device on the one hand and to a respective stationary holding element on the other hand.

The torques exertable on the pivoting device by the torsional springs are preferably opposed to each other.

It is favorable if the torsional springs strike against a respective stop element as explained above when the pivoting device adopts the base position. In the base position of the pivoting device, advantageously no restoring force is exerted on the pivoting device by way of any of the torsional springs, in order to better define the base position relative to the support part. The torsional springs advantageously bear against the respective stop element under pretension. The pivoting in each of the pivoting directions leads to a restoring force of one of the torsional springs. If the torque is no longer applied to the rotary body, a restoring torque from the torsional spring then acts on the pivoting device.

The pivoting device in the base position is preferably free of restoring forces and torques, respectively, exertable by way of the torsional springs.

It is favorable if two or more brush segments comprise a pivoting device with a rotary body, wherein the rotary bodies are pivotable independently of each other about the pivotal axis relative to the support part by way of the respective pivoting device. In this way, an even better adaptation of the vehicle treatment brush to the contour of the vehicle is possible. Advantageously all brush segments comprise a pivoting device with a rotary body which is pivotable relative to the support part by way of the respective pivoting device.

A respective brush segment advantageously comprises at least one restoring device and particularly preferably two restoring devices. The advantages mentioned above may thereby be achieved with each brush segment.

It is favorable if the support part is non-driven. “Non-driven” may presently be understood in particular as the support part not being set into rotation about the pivotal axis by way of the drive device. The support part may, for example deviating from the drive shaft used in DE 27 33 091, remain unmoved despite the rotation of the rotary body. This offers, in particular, the possibility of optimizing the mounting of the brush segments on the support part, the drive device for rotating the at least one rotary body, and the at least one restoring device, independently of each other. For example, a necessary structure and hold may be given to the vehicle treatment brush by way of the support part, wherein the moving mass may be kept relatively small due to the non-driven support part. The mass thereof, too, may be kept small, because only holding forces are to be applied via the support part, but no torque has to be transmitted. For this purpose, it is particularly advantageous in particular if the support part forms a hollow body, for example a support tube. “Non-driven” does not exclude in the present case, however, that the support part may be passively or actively moved by means of an actuator, in order to enable advancing the vehicle treatment brush to the vehicle. This may concern an inclination of the vehicle treatment brush in order to enable a coarse adaptation thereof to the contour of the vehicle upon the advancement of said vehicle treatment brush and/or a displacement of the vehicle treatment brush.

The brush segments are favorably of identical configuration in order to achieve a simple construction. In particular, the respective restoring devices may be of identical configuration.

In an advantageous implementation of the vehicle treatment brush, provision may be made for the rotary bodies of two or more brush segments to be drivable by means of a drive motor of the drive device. Two or more rotary bodies may be driven with only one drive motor. It is also conceivable for the rotary bodies of all brush segments to be able to be driven by means of only one drive motor.

In an advantageous embodiment of a different kind, provision may be made for the drive device to comprise a plurality of drive motors, and for a drive motor to be associated with each brush segment for driving the respective rotary body. This makes it possible to individually drive the rotary bodies of the different brush segments. For example, it is thereby possible to drive the rotary bodies of the brush segments at different speeds, such that the vehicle regions struck by the cleaning elements of the respective brush segment may, for example, be cleaned off with different intensities. For example, a faster rotation of the rotary body and, as a result thereof, a more intensive cleaning of the vehicle occurs at lower vehicle regions at which greater soiling is typically present due to the proximity to the ground than in vehicle regions distant from the ground. The drive motors are preferably adjustable for adjusting the rotational speed of the respective rotary body.

The pivotal axis and the rotational axis and rotational axes, respectively, provided that a plurality of rotary bodies as presently described are present, are favorably aligned in parallel to each other.

In the present case, the pivoting of the rotary body relative of the support part may also be understood as a pivoting of the pivoting device comprising the latter relative to the support part, and vice versa.

It proves to be favorable if the pivoting device comprises at least one pivotal body which is pivotable about the pivotal axis and relative to which the rotary body is configured to be rotational, wherein the at least one pivotal body is coupled to the rotary body and the restoring force of the torsional spring engages on the at least one pivotal body. The at least one pivotal body and the rotary body form catches for each other for the purposes of pivoting. In the case of a protruding vehicle contour, a torque is exerted on the rotary body by way of the cleaning elements. This leads to the rotary body being pivoted by way of the at least one pivotal body, wherein the rotational movement of the rotary body is able to be maintained due to the rotational configuration. If the torque is no longer applied, a pivoting back of the rotary body occurs by the restoring force being exerted directly or indirectly on the pivotal body which catches the rotary body upon the pivotal movement.

The pivoting device advantageously comprises at least one bearing element by way of which the at least one pivotal body and the rotary body are mounted on each other. The bearing may be a ball bearing or a sliding bearing, wherein a fictional engagement between the rotary body and the pivotal body, mediated by means of a ball bearing, has proven to be advantageous. For example, an axial bearing by means of a bearing ring is used, by way of which the at least one pivotal body bears on the rotary body.

In particular in the case of the last mentioned advantageous embodiment, provision is favorably made for the at least one pivotal body to comprise or form a covering element which covers the rotary body transversely to the rotational axis. This proves to be advantageous in a housing-like configuration of the pivoting device, in order to avoid the entry of dirt and cleaning liquid into the housing.

The at least one pivotal body is of plate-shaped configuration in an advantageous embodiment.

It is favorable if the pivoting device comprises two pivotal bodies arranged axially on opposing sides of the rotary body. The pivotal bodies may be spaced axially apart from each other, wherein the rotary body is arranged between them and a respective bearing element is advantageously provided between a pivotal body and the rotary body.

The pivoting device preferably forms a housing with an outer wall formed by the rotary body and top walls formed by the pivotal bodies, wherein the support part passes through the housing. As a result of the housing-like configuration, the entry of dirt and cleaning liquid is impeded and a reliable functioning of the vehicle treatment brush thereby ensured. For example, the rotary body is an internal gear which is driven by way of a drive element arranged in the interior of the housing.

It is advantageous if the pivoting device comprises a bearing element, by way of which the at least one pivotal body is mounted on the support part or on a sleeve-shaped bearing body of the brush segment surrounding said support part. The bearing element, in particular a radial bearing, may be configured as a ball bearing or as a sliding bearing. It is conceivable for a direct mounting of the at least one pivotal body on the support part to take place by way of the bearing element. An indirect mounting is also possible, wherein the at least one pivotal body is mounted on the bearing body which, in turn, surrounds the support part.

The bearing body may be of one-part or multi-part configuration.

The use of a bearing body proves to be advantageous, for example, in the assembly and in the maintenance of the vehicle treatment brush. Due to possible tolerances in the production, the pivoting device may be mounted in a simpler manner if the bearing body surrounds the support part with play. Play may be present in radial direction between the bearing body and the support part in order to compensate production tolerances and to attach the pivoting device and the bearing element to the support part in a simple manner. In the case of wear, the bearing body may be removed and exchanged or treated, for example, such that maintenance on the support part may be omitted.

It proves to be advantageous if the bearing body is axially immovably fixed relative to the support part by positive and/or force lock.

It is favorable if the brush segment comprises at least one holding body which is arranged axially, in relation to the pivotal axis, next to the at least one pivotal body or the bearing body, is secured on the support part, and on which the at least one pivotal body or the bearing body is axially and/or radially mounted by way of at least one bearing element.

The at least one pivotal body or the bearing body may be supported in axial and/or radial direction on the at least one holding body by way of the at least one bearing element, thereby resulting in a reliable fixation. The bearing element may be configured as a ball bearing or a sliding bearing and as an axial bearing or as a radial bearing.

In an advantageous embodiment, a radial bearing is provided in the form of a ball bearing, arranged between the at least one pivotal body and the bearing body, and a radial bearing configured as a ball bearing arranged between the bearing body and the at least one holding body. The holding body may cover the bearing element on the outside. The entry of dirt and cleaning liquid may thereby be impeded. The at least one holding body may be secured on the support part by force lock and/or positive lock.

It proves to be favorable if the brush segment comprises two holding bodies which are arranged axially on opposite sides of the rotary body. In particular, when two pivotal bodies are present, as explained above, in each case one holding body may be provided. The bearing body may extend from the first holding body in axial direction to the second holding body.

It is advantageous if the support part is configured as a support tube. The mass of the support part may thereby be kept small. A robust structure may nevertheless be given to the support part and thus to the vehicle treatment brush.

The support tube preferably has a round cross section and in particular circular cross section, though cross sections of different kinds may also be provided (polygonal, non-round . . . ).

In an advantageous embodiment of the vehicle treatment brush, the drive device comprises at least one drive motor and at least one drive wheel which is driven by the latter, is arranged in the support tube, is aligned eccentrically to the pivotal axis, and which passes in sections through the at least one through-opening formed in the support tube, wherein the at least one drive wheel is in operative connection with the rotary body. This offers the possibility of an internal drive, arranged in the support tube and protected from outside influences. The drive wheel is positioned at least in sections thereof within the support tube and is arranged eccentrically to the pivotal axis. This allows for a section of the drive wheel to pass through the through-opening in the support tube. The drive wheel may be operatively connected to the rotary body directly or indirectly, in particular by way of a further wheel.

Provision is advantageously made for the brush segment to comprise at least one coupling wheel with an inside and an outside, wherein the at least one drive wheel is in engagement on the inside with the at least one coupling wheel, and wherein the rotary body is configured as an internal gear, the inside of which is in engagement with the outside of the at least one coupling wheel. The coupling wheel enables a transmission of the driving force from the drive wheel to the rotary body. For this purpose, the coupling wheel surrounds the support part and is driven on the inside by the drive wheel, wherein it is in engagement with the rotary body on the outside.

The use of a drive wheel together with the coupling wheel makes it possible, for example, to vary in a simple manner the torque range transmittable to the rotary body, without the pivoting device needing to be modified for this. The translation and thus the torque range being applied to the rotary body may take place in a simple manner through an exchange of the drive wheel and the coupling wheel.

It proves to be advantageous if the at least one drive wheel is in engagement with the at least one coupling wheel by way of a tooth arrangement, and/or if the at least one coupling wheel is in engagement with the at least one rotary body by way of a tooth arrangement.

It is favorable if the at least one coupling wheel is aligned coaxially to the support tube.

An advantageous embodiment of the vehicle treatment brush makes provision for the brush segment to comprise at least one sleeve-shaped bearing body which surrounds the support tube and comprises or forms the at least one coupling wheel or on which the at least one coupling wheel is secured. This concerns in particular the sleeve-shaped bearing body mentioned above, on which the at least one pivotal body of the pivoting device may be mounted.

For driving the at least one drive wheel, it proves to be advantageous if the drive device comprises at least one drive shaft which is driven by the at least one drive motor and on which the at least one drive wheel is non-rotatably held.

In an advantageous embodiment, it is favorable if a drive shaft is provided, on which a plurality of drive wheels is non-rotatably held, wherein a respective rotary body of the brush segments is drivable by way of a respective drive wheel. As mentioned above, a plurality of brush segments may be provided with drivable rotary bodies. For at least two and in particular all such brush segments, a common drive shaft may be used in the present embodiment. A plurality of drive wheels is held on the drive shaft in order to drive the respective rotary body.

In an advantageous embodiment of a different kind, it is favorable if the drive device comprises a plurality of drive motors which drive a respective drive wheel, wherein a drive motor is associated with a respective brush segment for driving the rotary body thereof. The brush segments each having a rotatable rotary body may thereby be individually driven, including the possibility of different rotational speeds. In particular, a respective drive motor may be arranged in the support tube and associated with a brush segment, the rotary body of which it drives.

For a reliable functioning of the vehicle treatment brush, it proves to be advantageous if the at least one drive shaft is rotatably mounted in the support tube by way of a bearing bush. For mounting the drive shaft, the bearing bush may comprise or form a bearing element. The bearing element may be a sliding bearing or a ball bearing.

The at least one bearing bush is advantageously secured on the support tube by way of at least one fixing element passing through the latter from outside to inside. In this way, a simple assembly of the vehicle treatment brush is possible, in which the at least one bearing bush is secured on the support tube from the outside by means of at least one fixing element.

In a corresponding manner, in the case of a drive motor arranged in the support tube, provision may be made for a respective drive motor in the support tube to be secured on the support tube by way of at least one fixing element passing through the latter from outside to inside.

The at least one holding body has already been described above, for the axial and/or radial mounting of the at least one pivotal body or the bearing body.

A holding body is advantageously secured on the support tube by way of the at least one fixing element, on which holding body the pivoting device or a bearing body is axially and/or radially supported. The supporting may occur by way of a bearing element, configured as a ball bearing or as a sliding bearing.

In an advantageous embodiment of the vehicle treatment brush, provision may be made for the brush segment to comprise a drive motor held on the pivoting device and a drive wheel driven by the latter, which drive wheel is directly or indirectly in operative connection with the rotary body of the brush segment. This offers in particular the possibility of associating a drive motor to a respective brush segment with a pivoting device and rotary body and individually driving the rotary bodies. The drive motor is held on the pivoting device and may be pivoted together with the latter relative to the support part.

The rotary body is advantageously configured as an internal gear, wherein an outside of the drive wheel rolls on the inside on the rotary body.

It is favorable if the drive wheel is in engagement with the rotary body by way of a tooth arrangement.

It proves to be advantageous if the drive motor is positioned on or in a housing which is formed by the pivoting device and which forms a receiving space into/in which a drive shaft of the drive motor engages/is arranged, on which the drive wheel is non-rotatably held. The receiving space is an inner space of the housing. The housing protects against dirt and cleaning liquid.

The vehicle treatment brush may be a side brush or a roof brush.

The cleaning elements may be bristles, washing strips, or polishing strips, i.e. strip-shaped washing elements or strip-shaped polishing elements.

The object stated at the outset is achieved by a vehicle treatment installation in accordance with the invention, comprising at least one vehicle treatment brush, in particular washing brush, of the aforementioned kind.

The advantages which were already mentioned in conjunction with the explanation of the vehicle treatment brush in accordance with the invention may also be achieved with the vehicle treatment installation. Reference may be made to the preceding remarks in this regard.

Advantageous embodiments of the vehicle treatment installation in accordance with the invention result from advantageous embodiments of the vehicle treatment brush in accordance with the invention.

The vehicle treatment installation may be a gantry-type installation or a conveying treatment installation.

The vehicle treatment installation may have at least one actuator for moving the vehicle treatment brush relative to the vehicle. For example, a displacement in longitudinal direction and/or transverse direction of the vehicle is possible. Alternatively or in addition, an inclination or tilting of the vehicle treatment brush relative to the vertical is provided in order to already carry out a coarse adaptation to the contour of the vehicle when advancing the vehicle treatment brush.

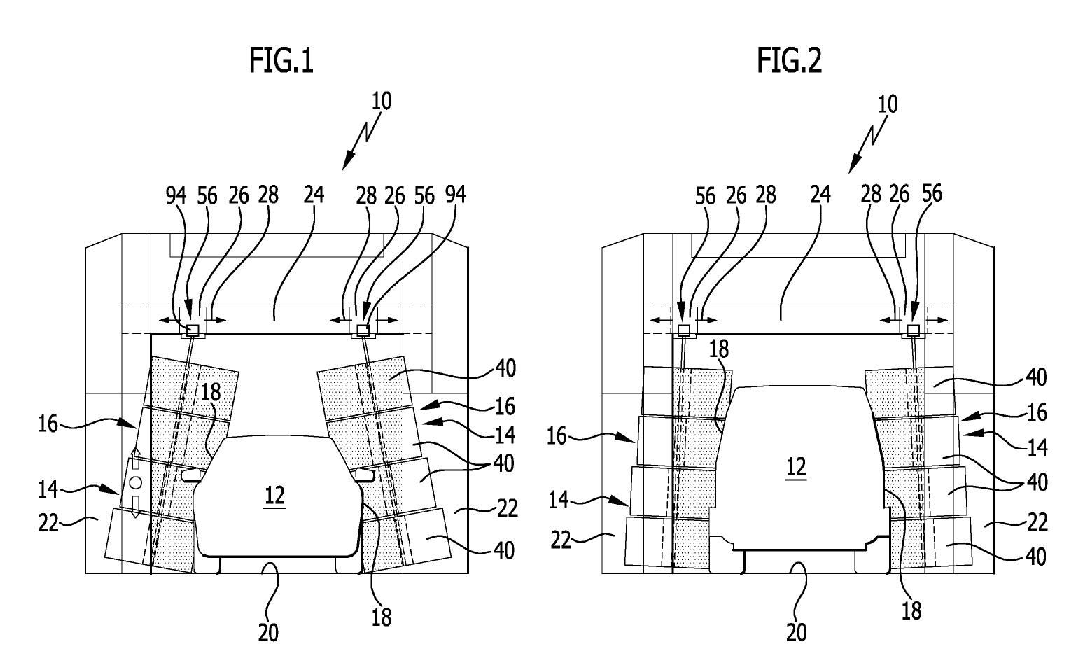

FIGS. 1 and 2 show schematically a preferred embodiment of a vehicle treatment installation in accordance with the invention, configured as a gantry-type washing installation 10 (subsequently: washing installation) for cleaning purposes, and in particular for washing a vehicle 12. FIGS. 1 and 2 show for example as the vehicle 12 a small vehicle and a van, respectively, which differ from each other in their contours. Viewed transversely to the vehicle longitudinal direction, the small vehicle has a roughly trapezoidal contour, whereas the van has a more rectangular contour.

For improved cleaning of vehicles 12 also having different contours, the washing installation 10 comprises two instances of a preferred embodiment of a vehicle treatment brush in accordance with the invention, which is presently configured as a vehicle washing brush 14 (subsequently washing brush 14). The washing brush 14 is a side brush 16 for cleaning lateral vehicle surfaces 18 of the vehicle 12. In a different kind of implementation of the invention, a “roof” brush may be provided as the washing brush 14 in accordance with the invention for cleaning upper vehicle regions, in particular the roof.

The washing brushes 14 are formed identically and symmetrically to each other with respect to function, such that only one washing brush 14 is described in the following.

The washing installation 10 comprises two vertical supports 22 which are positioned on a supporting surface 20 and are movable relative to the vehicle 12 in the longitudinal direction thereof. The vertical supports 22 are connected to each other by way of a transverse support 24 which is able to be moved relative to the vehicle 12 together with the vertical supports 22.

The washing brushes 14 are held on the transverse support 24 so as to be positionally variable by means of at least one actuator 26. In particular, the washing brushes 14 may be displaced on the transverse support 24 transversely to the vehicle direction, symbolized by arrows 28, by way of the actuator.

Moreover, the inclination of the washing brush 14 secured on the actuator 26 may be adjusted relative to the vertical by means of the actuator 26. In this way and with additional displacement of the washing brush 14, it is possible to approximately adapt the washing brush 14 to the contour of the vehicle 12 in a manner known per se when advancing said washing brush 14 to the vehicle 12.

While in the case of the small vehicle in FIG. 1 a steeper inclination of the washing brush 14 relative to the vertical is required and a smaller distance in transverse direction 28 between the washing brushes 14, FIG. 2 shows washing brushes 14 only slightly inclined in relation to the vertical due to the rather rectangular contour of the van, which washing brushes 14 furthermore adopt a greater distance from each other than in the example of FIG. 1.

In a different kind of advantageous embodiment, a vehicle treatment installation in accordance with the invention may be provided, which is configured as a conveying treatment installation and in particular as a conveying washing installation for the vehicle 12. The vehicle 12 may thereby be moved relative to the washing brushes 14 by means of a conveying apparatus.

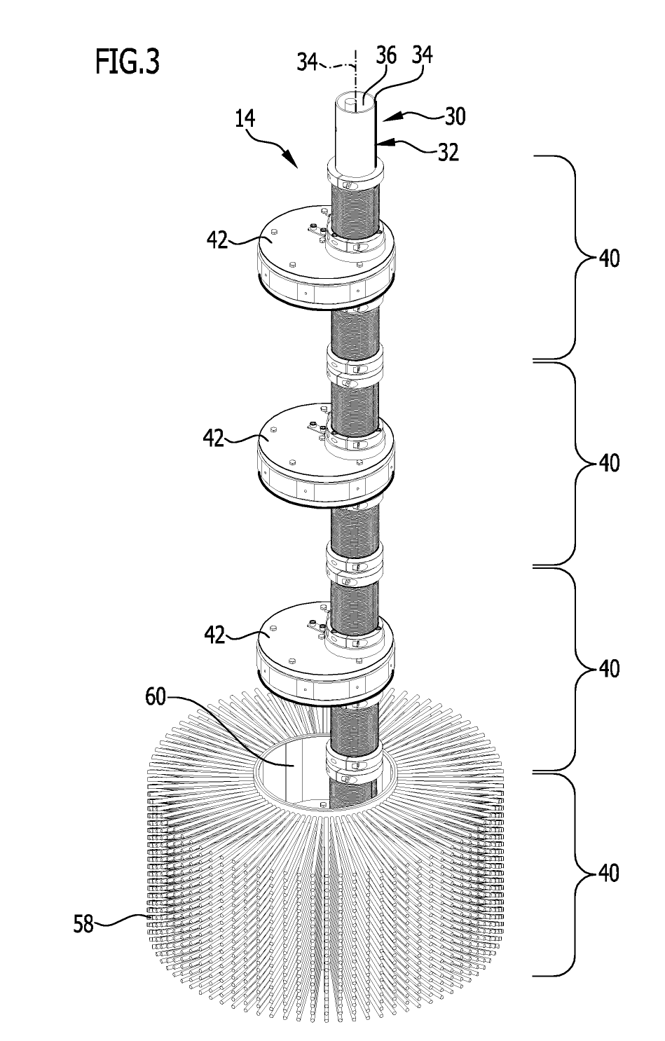

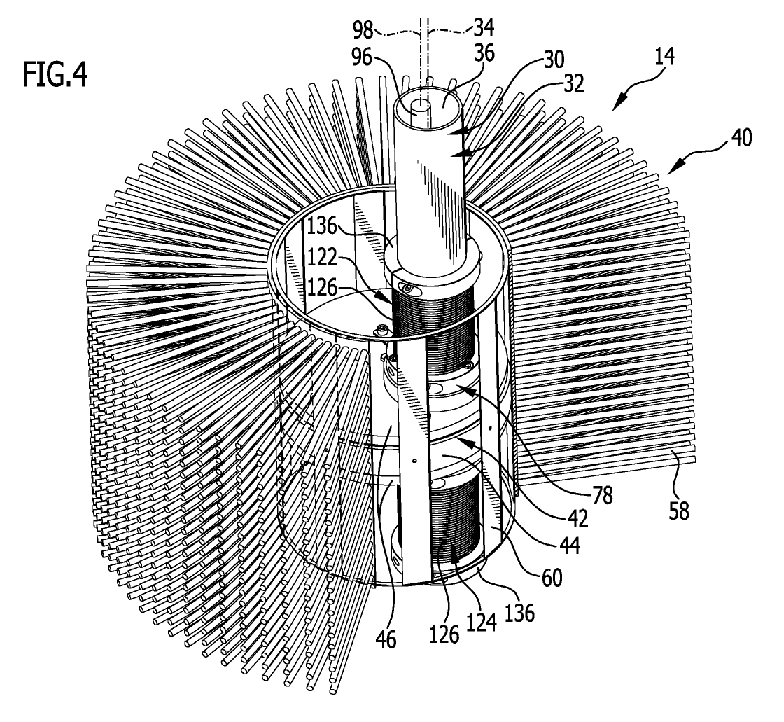

A good cleaning result may be achieved with the washing brush 14 in accordance with the invention upon cleaning the vehicle 12, because the washing brush 14 is able to adapt, at least within certain limits, to the contour of the vehicle 12, whereby convex bulges or concave recesses in the contour are able to be struck and cleaned by the cleaning elements in a better manner. With reference to FIGS. 3 to 8, the configuration of the washing brush 14 is described in the following.

The washing brush 14 comprises a support part 30 which is presently configured as a support tube 32 and defines an axis. The axis is a pivotal axis 34. The support tube 32 comprises a wall 36 and an inner space 38 enclosed by said wall 36.

“Axial” and “radial” are presently, insofar as not further described, to be interpreted as in relation to the pivotal axis 34.

Indications of position and orientation like, for example, “at the top”, “at the bottom” or the like are presently to be interpreted as with respect to an intended use of the washing brush 14 as a side washing brush which is held on the transverse support 24 hanging in a vertical direction or an inclined direction.

The washing brush 14 is subdivided axially into a plurality of brush segments 40. Presently four brush segments 40 are present, the count of which could also be different, however. The height of each brush segment 40 is about 40 cm, for example.

The brush segments 40 are presently of identical configuration. In FIGS. 3 to 8, the drawing shows only one brush segment 40 entirely or partially, the structure of which is explained in the following.

Each brush segment 40 comprises a section of the support tube 32, such that the individual sections of the support tube 32 form the same as a whole.

Each brush segment 40 comprises a pivoting device 42 with a rotary body 44 and two pivotal bodies 46. The pivoting device 42 forms a housing 48 with an inner space 50. The pivotal bodies 46 which are spaced axially apart from each other form top walls of the housing 48. The rotary body 44 forms an outer wall of the housing 48. The pivotal bodies 46 of plate-like configuration are positioned axially on opposing sides of the rotary body 44. The support tube 32 passes through the housing 48. For this purpose, through-openings 52 are formed in the pivotal bodies 46.

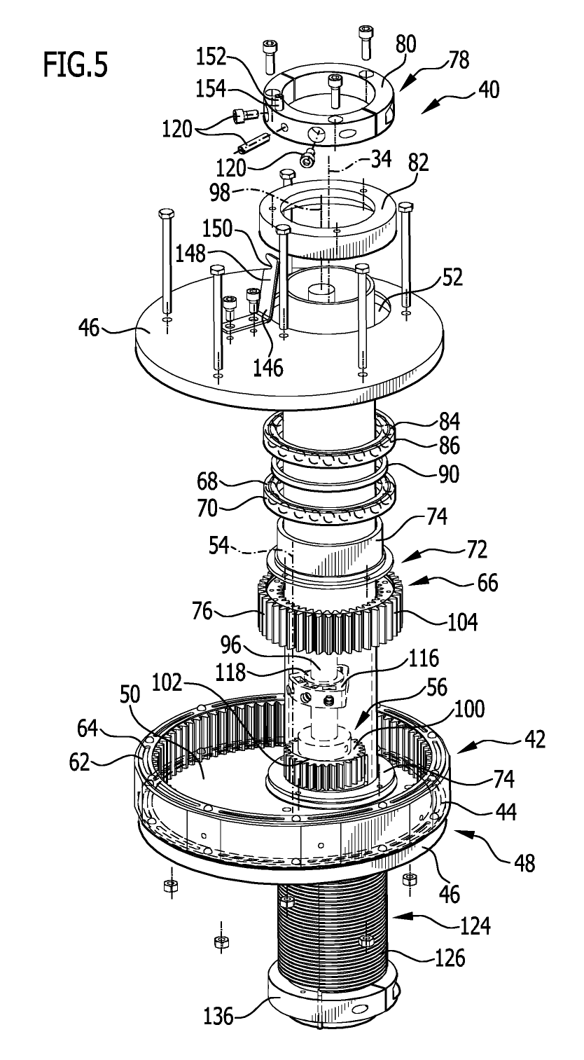

The pivotal bodies 46 are connected to each other, for example by screw-nut pairs shown in FIG. 5 or comparable tie rods.

The rotary body 44 is presently of annular configuration and defines a rotational axis 54 of the brush segment 40, about which the rotary body 44 is drivable in a rotational manner by means of a drive device 56 as subsequently explained. The rotational axis 54 is aligned in parallel to the pivotal axis 34, such that the support tube 32 is positioned eccentrically in relation to the rotary body 44. Vice versa, the rotary body 44 is positioned eccentrically in relation to the support tube 32. The pivotal bodies 46 are aligned coaxially to the rotary body 44.

Cleaning elements 58, presently in the form of bristles, are secured directly or indirectly on the rotary body 44. In the case of the washing brush 14, a holding body 60 which is secured radially outside on the rotary body 44 and is thereby non-rotatably connected to the same is provided for securing the cleaning elements 58. The holding body 60 has a drum-like or reel-like form (without the side cheeks otherwise present in drums or reels) which may also be referred to as cage-like. The cleaning elements 58 are secured radially outside on the holding body 60 and are set into a rotation by a rotation of the rotary body 44.

The cleaning elements 58 are presently flexible, such that they are able to bend upon contact with the vehicle 12, wherein the degree of bend depends on the contact force on the vehicle 12.

The brush segments 40 are configured such that only a small gap free of cleaning elements 58 is present in axial direction between the cleaning elements 58 of adjacent brush segments 40 (FIGS. 1 and 2). The cleaning elements 58 thereby extend in axial direction substantially over the entire axial length of the brush segments 40 as a whole.

The rotary body 44 is rotatably mounted on the pivotal bodies 46 by way of concentrically aligned bearing elements 62 and is rotatable in relation to said pivotal bodies 46. The bearing element 62 is in each case designed as an, in particular, axial bearing ring 64 and is presently configured as a ball bearing. Alternatively, a sliding bearing may be used.

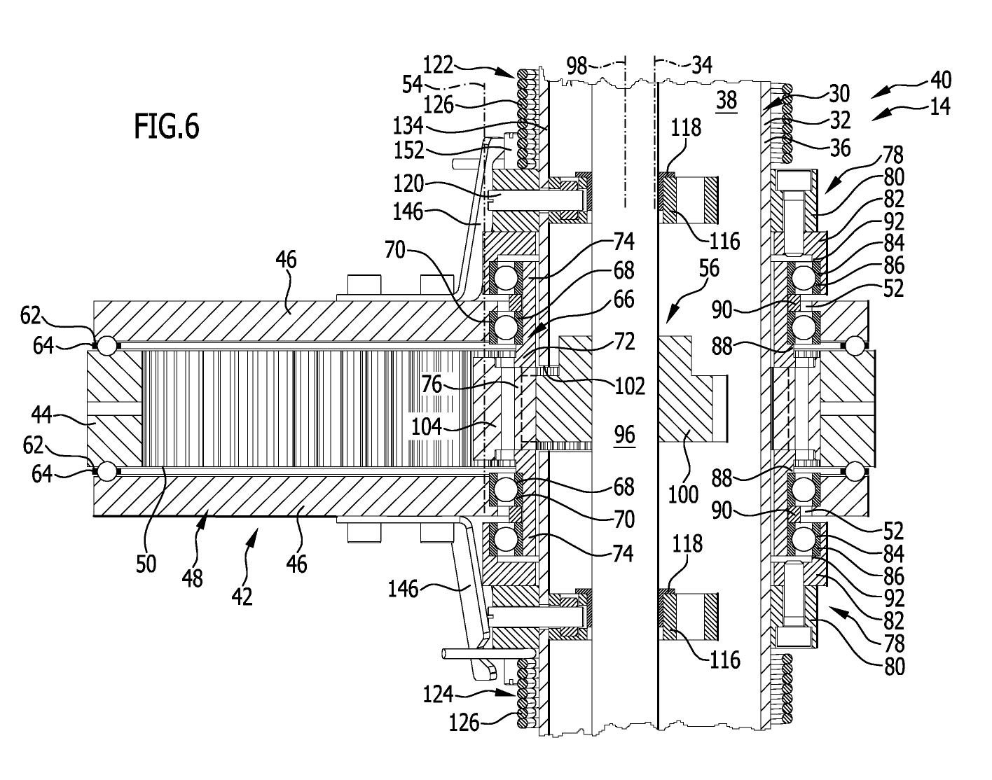

The pivoting device 42 is pivotable relative to the support tube 32 about the pivotal axis 34 thereof. For this purpose, the pivotal bodies 46 are pivotably mounted on a bearing body 66, wherein a respective bearing element 68 serves for mounting a respective pivotal body 46 on the bearing body 66. The bearing element 68 is presently configured as a bearing ring 70 and as a ball bearing. Alternatively, a sliding bearing may be provided. As may be gathered in particular from FIG. 6, the bearing ring 70 is positioned radially between the pivotal body 46 and the bearing body 66.

The bearing body 66 is presently configured as a bearing sleeve 72 that surrounds the support tube 32. The bearing sleeve 72 is aligned coaxially to the support tube 32. It is advantageous, however, if some play is present between the bearing sleeve 72 and the support tube 32. This serves, for example, for simpler assembly of the brush segment 40 and for compensating possible tolerances in production.

The bearing sleeve 72 is presently subdivided axially into three sections. Two sleeve sections 74 are provided, between which a middle section 76 is arranged. The sleeve sections 74 abut against the middle section 76 in the manner of a flange and are fixedly connected to the same, presently by a screw connection. A respective sleeve section 74 is associated with a bearing ring 70, by way of which a respective pivotal body 46 is mounted on the bearing sleeve 72.

In axial direction, each sleeve section 74 extends in the direction pointing away from the middle section 76 beyond the bearing ring 70 and the pivotal body 46. The middle section 76 is arranged in the inner space 50 of the housing 48.

The brush segment 40 comprises two holding bodies 78 for axially fixing the pivoting device 42, which holding bodies 78 are arranged on opposing sides of the housing 48 and the bearing sleeve 72. The bearing sleeve 72 and, by way of the same, the pivoting device 42 may be supported in axial direction indirectly on a respective holding body 78 and in this way are secured against a movement in axial direction.

The holding body 78 is presently of multi-part configuration. The holding body 78 has a holding ring 80 secured on the support tube 32, which holding ring 80 is connected to the support tube 32, for example by screw connection. The holding ring 80 is connected to a fixing ring 82, for example by screw connection. The fixing ring 82 is positioned axially between the holding ring 80 and the bearing sleeve 72.

By way of a bearing element 84 in the form of a bearing ring 86, the section of the sleeve section 74 that projects axially over the pivotal body 46 and the bearing ring 70 is rotatably mounted on the holding body 78. The bearing ring 86 is presently configured as a ball bearing. Alternatively, a sliding bearing may be provided. The bearing ring 86 is positioned radially between the sleeve section 74 and an outer section of the fixing ring 82 which covers said sleeve section 74.

A respective shoulder 88 of the bearing sleeve 72 is supported on the bearing ring 70 in axial direction, which bearing ring 70 in turn abuts against the bearing ring 86 by way of an intermediate ring 90 and is supported on said bearing ring 86. The bearing ring 86 is supported in axial direction on a shoulder 92 of the fixing ring 82.

The drive device 56 presently serves for driving the rotary bodies 44 of all brush segments 40. The drive device 56 comprises a drive motor 94. The drive motor 94 is schematically depicted in FIGS. 1 and 2 and is held, e.g., on the transverse support 24 and is arranged in the region of the actuator 26. The drive motor 94 is configured such that the rotary bodies 44 may be selectively driven about the rotational axis 54 in one of the two rotational directions.

Furthermore, the drive device 56 comprises a drive shaft 96 which is driven by the drive motor 94 and defines a drive axis 98. The drive shaft 96 is arranged in the support tube 32 and is aligned eccentrically thereto, wherein the drive axis 98 and the pivotal axis 34 run parallel to each other.

The drive shaft 96 is rotatably mounted in the support tube 32 by way of bearing bushes 116. For example, two bearing bushes 116 are associated with each brush segment 40 (FIGS. 5 and 6). The drive shaft 96 passes through a respective bearing bush 116 on which a bearing ring 118, presently configured as a sliding bearing, is arranged. Alternatively, a ball bearing may be provided.

Fixing elements 120, presently configured as screws, are used for securing the bearing bush 116. It is favorable if the fixing elements 120 simultaneously serve to fix the holding ring 80 of the holding body 78 on the support tube 32.

The screw-shaped fixing elements 120 pass through the holding ring 80 and the wall 36 from outside to inside and are in engagement with the bearing bush 116 in the inner space 38 (FIG. 6). Separate fixing elements for the holding body 78 on the one hand and for the bearing bush 116 on the other hand may thereby be saved. In addition, the assembly of the washing brush 14 is simplified by fixing the bearing bush 116 from the outside.

Associated with each brush segment 40, the drive device 56 has a drive wheel 100 which is non-rotatably held on the drive shaft 96. The drive wheel 100 is aligned coaxially to the drive shaft 96 and thus eccentrically to the pivotal axis 34. The drive wheel 100 is dimensioned such that it can pass in sections through a respective through-opening 102 formed in the wall 36. In this way, a respective section of the drive wheel 100 can project out of the inner space 38 and over the wall 36 in radial direction (FIGS. 5 and 6).

The rotary body 44 is presently configured as an internal gear which is indirectly in operative connection with the drive device 56 and in particular the drive wheel 100 thereof. For this purpose, the drive device 56 presently has a coupling wheel 104, the inside of which is in engagement with the drive wheel 100 and the outside of which is in engagement with the rotary body 44.

The coupling wheel 104 is presently formed by the middle section 76 and thus by the bearing body 66. In this way, in addition to mounting the pivotal body 46, the bearing body 66 performs an additional function with the transmission of the driving force from the drive wheel 100 to the rotary body 44.

In the present case, the rotary body 44 and the drive wheel 100 have a tooth arrangement and the coupling wheel 104 is provided with a tooth arrangement both on the inside and on the outside. In this way, the driving force may be reliably transmitted from the drive shaft 96 to the rotary body 44.

Alternatively, a frictional engagement between the drive wheel 100 and the coupling wheel 104 and/or between the coupling wheel 104 and the rotary body 44 is conceivable.

In an embodiment of a different kind, provision may be made for two bearing bodies and in particular bearing sleeves to be associated with the pivoting device 42. For example, the coupling wheel 104 could, differently than described, be connected not non-rotatably to the section mounting the pivotal body 46. For this purpose, an axial ball or sliding bearing between the coupling wheel 104 and the pivotal body 46, for example, is conceivable.

In an advantageous embodiment of a different kind, provision may be made for the pivotal body 46 to not be mounted by way of the bearing body 66, but rather directly on the support tube 32, advantageously by way of a bearing element. In this case too, an axial bearing may be provided between the coupling wheel 104 and the pivotal body 46, as described above.

The rotary body 44 may be pivoted about the pivotal axis 34 relative to the support tube 32 by way of the pivoting device 42. This may also be regarded as a pivoting of the pivoting device 42, the constituent part of which is the rotary body 44, relative to the support tube 32 about the pivotal axis 34. Due to the rotational configuration of the rotary body 44 relative to the pivotal bodies 46, the rotary body 44 may be driven by way of the drive device 56 independently of the pivot position.

A contour-dependent cleaning of the vehicle 12 may be performed by means of the washing brush 14 in accordance with the invention. With each brush segment 40, the pivoting device 42, and thus the facing on the cleaning elements 58, may be pivoted about the support tube 32 in dependence on the vehicle contour, but independently of the other brush segments 40.

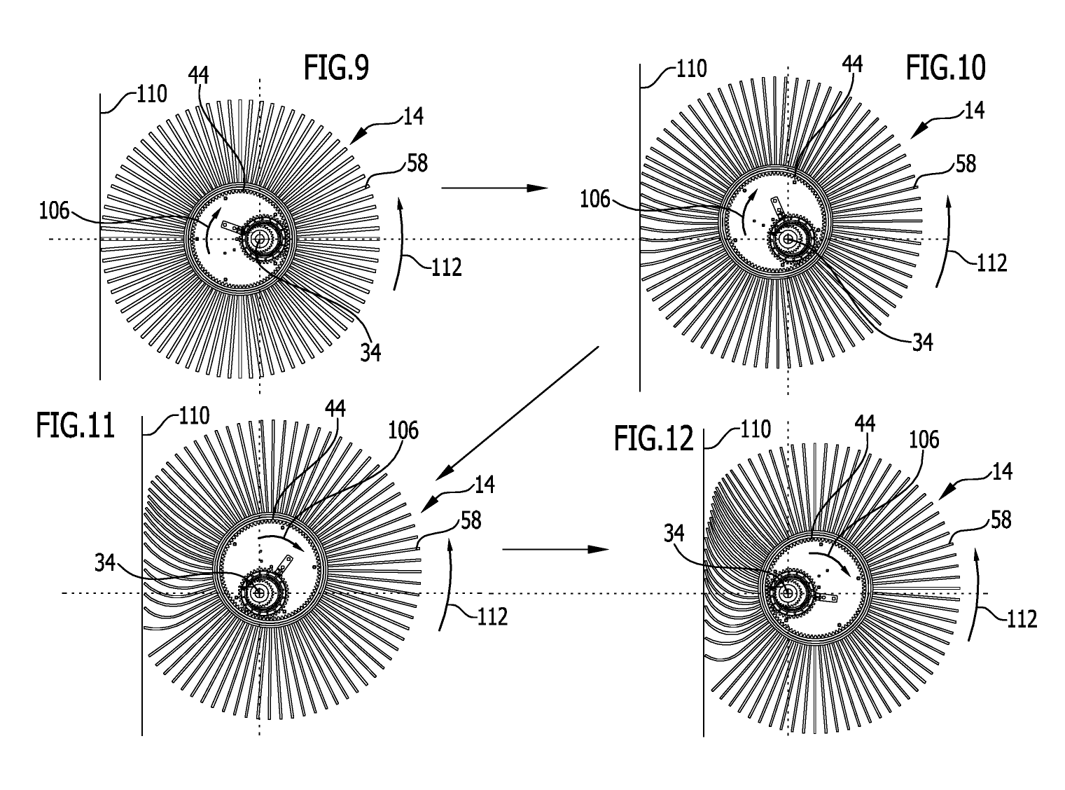

In this case, a pivoting about the pivotal axis 34 in two opposite pivot directions 106 and 108 is possible (FIGS. 9 to 12 and 13 to 16, respectively). The maximum pivot angle is preferably in each case about 180°. Because the pivoting devices 42 of the different brush segments 40 may be pivoted relative to the support tube 32 independently of each other, the washing brush 14 is able to adapt to the different contours of the vehicles 12, as is depicted for example in FIGS. 1 and 2 and is explained with reference to FIGS. 9 to 16.

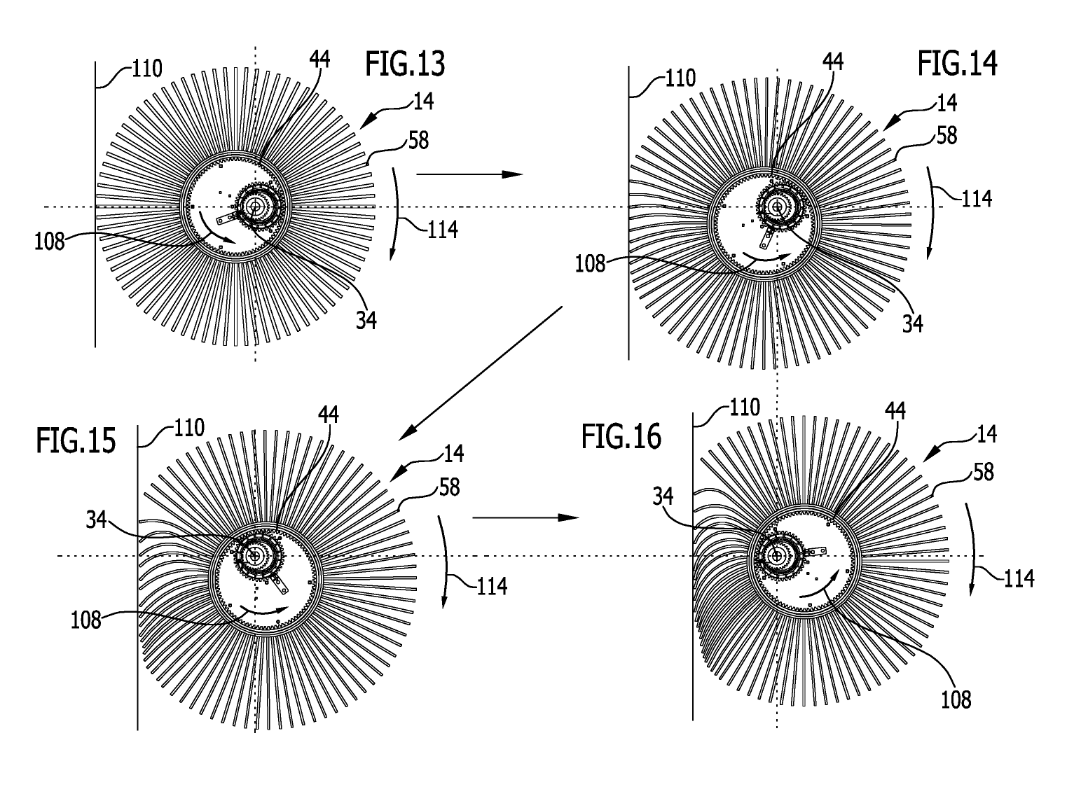

In FIGS. 9 to 16, the contour of the vehicle 12 is symbolized by a vertical line 110. While in the example of FIGS. 9 to 12 the rotary body 44 is driven in a rotational direction symbolized by an arrow 112, the rotary body 44 in the example of FIGS. 13 to 16 is driven in a rotational direction symbolized by the arrow 114. The rotational directions 112, 114 are mutually opposite.

In the example of FIGS. 9 to 12, a different distance of the washing brush 14 from the contour of the vehicle 12 symbolized by the line 110 is shown schematically. If the contour of the vehicle 12 approaches the washing brush 14, i.e. the distance of the vehicle contour relative to the support tube 32 regarded as stationary is reduced, then a torque is exerted on the pivoting device 42 by way of the cleaning elements 58. The torque is accommodated by the rotary body 44. The rotary body 44 is pivoted about the pivotal axis 34 relative to the support tube 32 by way of the pivoting device 42 as a result of the torque. The pivoting occurs in the pivot direction 106 that is opposite the rotational direction 112. The smaller the distance of the support tube 32 from the vehicle contour is, the greater the pivot angle is, and increases successively in the depictions of FIGS. 9 to 12.

FIGS. 13 to 16 show the corresponding case, wherein the rotary body 44 is driven in the opposite rotational direction 114. If the distance of the vehicle contour from the support tube 32 regarded as stationary is reduced, then in this case, too, the rotary body 44 pivots relative to the support tube 32 by way of the pivoting device 42. The pivoting occurs in the pivot direction 108 that is opposite the rotational direction 114.

It proves to be particularly advantageous in the case of the washing brush 14 for the support tube 32 to be non-driven. The drive device 56 does not act on the support tube 32, but rather only on the drive shaft 96 mounted therein. The moving mass of the washing brush 14 may thereby be kept small. In particular, the mass of the support tube 32 may be kept small and the latter may be configured to be relatively thin-walled. Only holding forces are to be applied by way of the support tube 32, but no torque is to be transmitted. This offers the possibility in particular of optimizing the mounting of the brush segments 40 on the support tube 40, on the one hand, and the drive device 56 for rotating the rotary bodies 44, on the other hand, independently of each other.

A better cleaning result may also be achieved in that the rotary body 44 may selectively be rotated in the rotational direction 112 or the rotational direction 114. The rotational direction 112, 114 may be varied depending on which contour on the vehicle 12 is to be cleaned. This makes it possible to better clean undercuts present on the vehicle 12, for example in the region of the exterior mirrors. Changes to the rotational direction 112, 114 may in particular also be made when cleaning the front of the vehicle and/or the rear of the vehicle.

The brush segment 40 comprises a first restoring device 122 and a second restoring device 124. Both restoring devices 122, 124 have a respective restoring element 126.

The restoring devices 122, 124 are of the same configuration with respect to function. However, the restoring devices 122, 124 are configured such that the pivoting of the pivoting device 42 in the pivot direction 106 occurs against the action of the restoring device 122. The pivoting of the pivoting device 42 in the pivot direction 108 occurs against the action of the restoring device 124. The respective other restoring device 124 and 122, respectively, exerts no effect on the pivoting device 42 upon pivoting in the pivot direction 106 and 108, respectively. In the following, substantially the restoring device 122 will be discussed, wherein the respective statements apply in corresponding manner to the restoring device 124.

The restoring devices 122, 124 are arranged axially on mutually opposite sides of the pivoting device 42. The restoring device 122 is positioned above the pivoting device 42 and the restoring device 124 beneath the pivoting device 42.

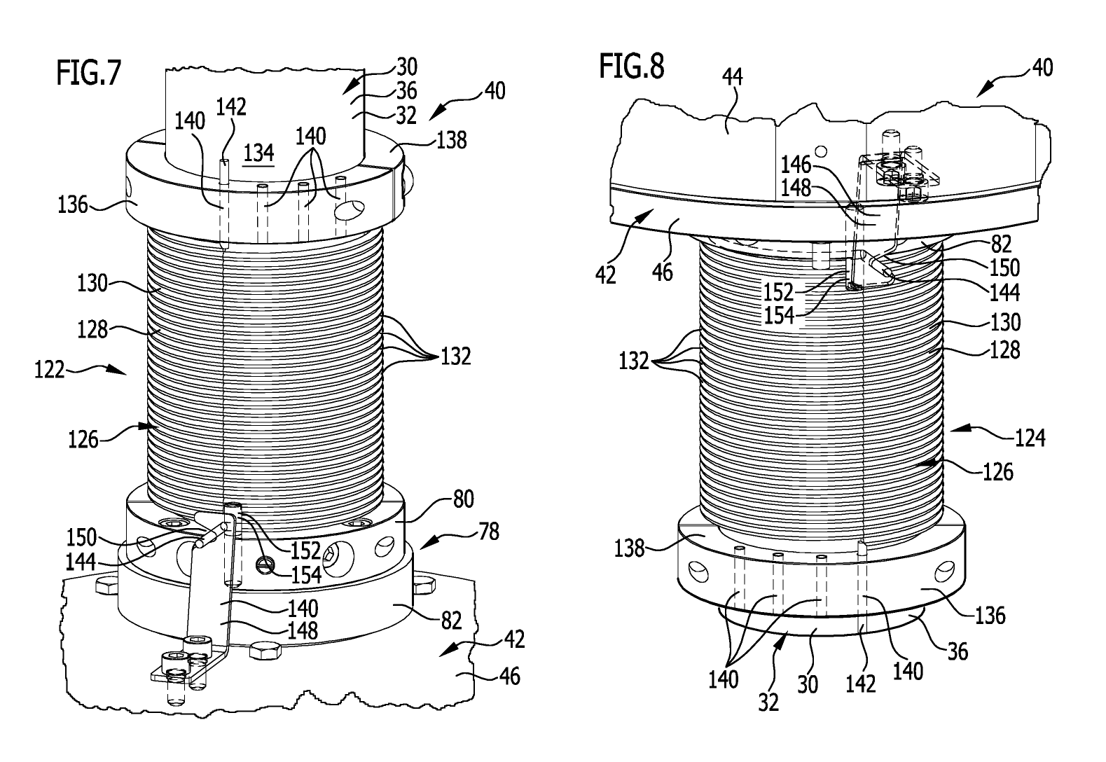

As may be gathered in particular from FIG. 7, the restoring element 126 is configured as an elastically deformable spring element 128. The spring element 128 is a torsional spring 130 which is configured as a coil spring with a multiplicity of windings 132. The torsional spring 130 surrounds the support tube 32. The support tube 32 serves in this way as a core 134 for accommodating the torsional spring 130. The torsional spring 130 is thereby reliably held in position on the support tube 32 and is secured against tilting moments which may occur when the torsional spring 130 is deformed.

Some play is present in radial direction between the windings 132 and the wall 36, in order to allow for a deformation of the torsional spring 130 when the pivoting device 42 is pivoted.

The torsional spring 130 is positioned independently of the position of the pivoting device 42 within the contour of the rotary body 44 and in particular does not project in radial direction beyond this contour. This ensures that the torsional spring 130 cannot come into contact with vehicle surfaces and damage them.

In axial direction, the torsional spring 130 is positioned between the holding body 78 supporting it (by way of the holding ring 80) and a holding element 136 on which the torsional spring 130 can also be supported in axial direction. The holding element 136 is stationary relative to the support tube 32 and likewise is non-driven by the drive device 56. In particular, the holding element 136 is fixed on the support tube 32 in the case of the washing brush 14. The holding element 136 is presently configured as a clamping ring 138 surrounding the support tube 32.

At least one receptacle 140 for an end section 142 of the torsional spring 130 is formed in the holding element 136. The receptacle 140 is configured as a through-opening. Preferably a plurality of receptacles 140 arranged in circumferential direction of the support tube 32 are present.

The end section 142 can engage into the receptacle 140, such that the holding element 136 forms a stationary engagement point for the torsional spring 130.

An end section 144 opposite the end section 142 engages on a stop element 146 which is secured on the pivotal body 46 facing toward the torsional spring 130. The stop element 146 forms a movable engagement point for the torsional spring 130. The end section 144 is, e.g., angled radially to the windings 132.

The stop element 146 is formed by a stop angle bracket 148 which is held on the pivotal body 46, e.g., by screwing. A recess 150 for accommodating the end section 144 is formed on the stop angle bracket 148. The recess 150 is open to one side, such that the end section 144 is able to exit the recess 150 and again be inserted into the same.

The restoring device 122 further comprises a stop element 152 which is likewise arranged stationary with respect to the support tube 32. The stop element 152 is presently a stop pin 154 which is arranged on the holding body 78 and in particular the holding ring 80 thereof. The stop pin 154 is screwed into the holding ring 80, for example.

The torsional spring 130 is configured such that it is under pretension when fixing to the holding element 136 and abutting against the stop element 152. For example, the torsional spring 130 is pretensioned by at least one winding 132 and in particular multiple windings 132.

The pivoting device 42 may adopt the base position, depicted in FIGS. 9 and 13, relative to the support tube 32. In the base position, the end sections 144 of both torsional springs 130 strike against the respective stop element 152 and engage into the recesses 150 of the respective stop angle bracket 148.

The stop elements 152 are positioned such that they are spaced slightly apart from each other in circumferential direction of the support tube 32, thus there is a smaller angular distance between the stop elements 152 along the pivot directions 106, 108. If the pivoting device 42 adopts the base position, then none of the torsional springs 130 exert a spring force and thus a torque on the pivoting device 42.

If a torque imparted by the cleaning elements 58 acts on the rotary body 44 and thus on the pivoting device 42, then a pivoting of the pivoting device 42 may take place commencing from the base position in the pivot direction 106 (FIGS. 9 to 12). The pivoting occurs against the action and the pretension of the torsional spring 130 of the restoring device 122. As a result of the pretension, it is ensured that a restoring force is already exerted on the pivoting device 42 when the pivoting begins, whereby the base position of the pivoting device 42 is defined in an even better manner.

Upon pivoting in the pivot direction 106, the torsional spring 130 of the restoring device 124, however, exerts no torque on the pivoting device 42, because the torsional spring 130 abuts against the stop element 152 of the restoring device 124, the torsional spring 130 thereby also not being subjected to tensile load.

Because the pivoting device 42 is pivoted as a whole, the stop angle bracket 148 of the restoring device 124 also pivots, wherein the end section 144 exits the recess 150. In reverse, the end section 144 is again guided into the recess 150 when pivoted back.

If the torque imparted via the cleaning elements 58 is no longer applied, a torque is exerted on the pivoting device 42 by way of the restoring force of the torsional spring 130, and said pivoting device 42 is pivoted back into the base position.

In a corresponding manner, it is possible to pivot the pivoting device 42 in the pivot direction 108 against the action and pretensioning force of the torsional spring 130 of the restoring device 124 (FIGS. 13 to 16). The torsional spring 130 of the restoring device 122 abuts against the stop element 152 thereof. It exerts no torque on the pivoting device 42 and is not subjected to tensile load. The stop angle bracket 148 of the restoring device 122 may be pivoted therewith. The pivoting back into the base position occurs in that a torque is exerted on the pivoting device 42 by way of the restoring force of the torsional spring 130 of the restoring device 124.

The torques which are extertable on the pivoting device 42 by the torsional springs 130 are opposite to each other. When pivoting out of the base position, a torque is presently exerted on the pivoting device only by way of in each case one torsional spring 130.

Providing the torsional springs 130 with a multiplicity of windings 132 and the present pretension proves in practice to be particularly advantageous for a reliable functioning of the washing brush 14. The spring elements 128 have a substantially linear characteristic curve. The pivoting of the pivoting device 42 in both pivot directions 106 and 108 occurs steadily and not abruptly when the vehicle contour approaches the washing brush 14. It is ensured in this way that the cleaning elements 58 have sufficient, but not excessive contact with the vehicle 12 at all times. As a result, an overall better cleaning result may be achieved.

The pivotal bodies 46 serve as catches for the rotary body 44 when they are pivoted by the pivoting device 42 under the restoring force of the respective torsional spring 130 for adopting the base position. Vice versa, the rotary body 44 acts as a catch for the pivotal bodies 46 as a result of the torque imparted by way of the cleaning elements 58.

The possibility of varying the pretension of the torsional spring 130 has a plurality of advantages. The restoring force of the torsional spring 130 changes, depending on into which receptacle 140 the end section 142 engages. It may thus be adjusted with what force on the rotary body 44 via the cleaning elements 58 the pivoting movement begins. Vice versa, the contact force of the cleaning elements 58 on the vehicle 12 and/or the pivot angle may be adjusted in order to influence the intensity of the cleaning of the vehicle 12.

When using different cleaning elements 58 that differ from each other in their specific friction coefficients, an identical or comparable contact force may be achieved by way of the pretension of the torsional spring 130.

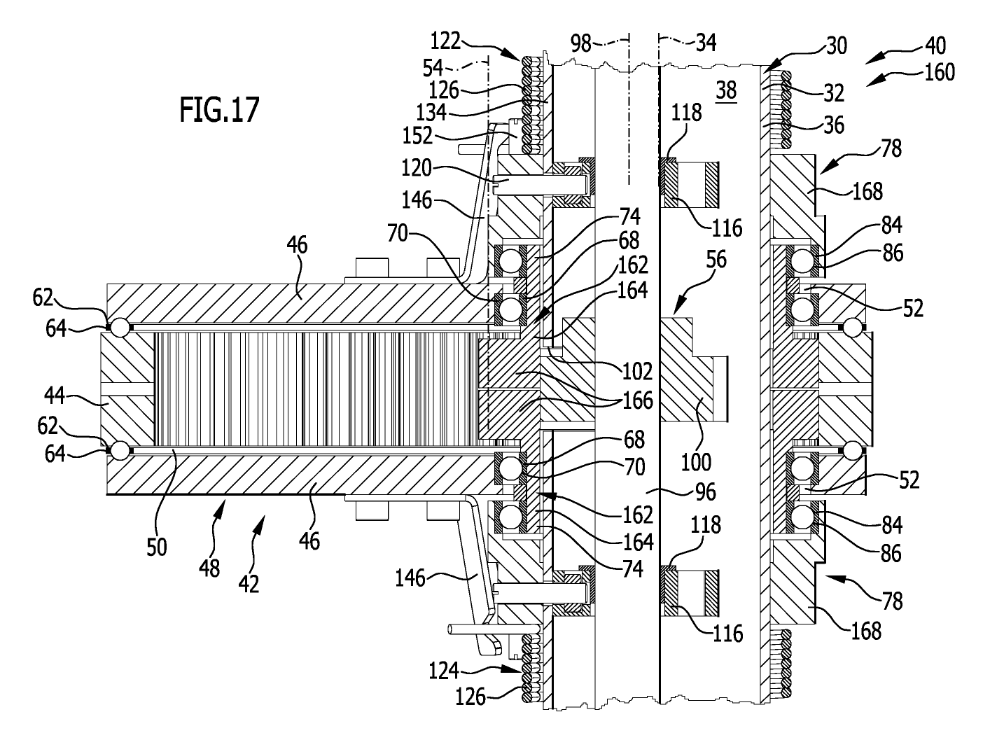

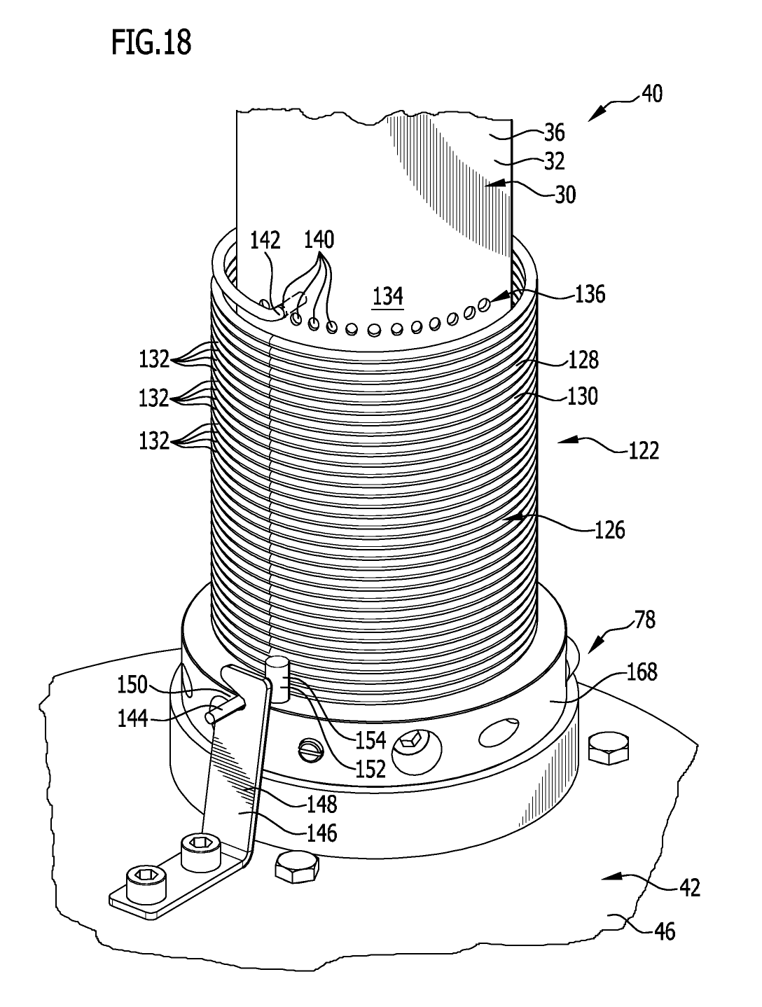

Further advantageous embodiments of the vehicle treatment brush in accordance with the invention are described in the following with reference to FIGS. 17 to 20. All vehicle treatment brushes are configured as vehicle washing brushes, which are subsequently referred to simply as washing brushes and are used in the washing installation 10.

Identical reference numerals are used for like or functionally equivalent features and components. The advantages mentioned in conjunction with the explanation of the washing brush 14 may likewise be achieved with the washing brushes explained in the following. In order to avoid repetition, reference may be made to the preceding statements. Substantially the differences will be discussed.

FIGS. 17 and 18 partially show a brush segment 40 of a washing brush designated with the reference numeral 160. FIG. 18 shows the restoring device 122 in a manner corresponding to FIG. 7. The following statements apply correspondingly for the restoring device 124.

In the case of washing brush 160, in place of the bearing body 66, two bearing bodies 162 are provided, each configured as a bearing sleeve 164. Instead of the three-part design of the bearing sleeve 72 with the sleeve sections 74 and the coupling wheel 104, there is a two-part design with two bearing sleeves 164 which each have a sleeve section 74 and a coupling wheel 166 that is preferably connected to the latter in a one-piece manner. The coupling wheels 166 are otherwise configured like the coupling wheel 104 and are provided together with an axial extent which corresponds to the axial extent of the coupling wheel 104. The bearing sleeves 164 may be connected to each other or be separated from each other. The drive wheel 100 is in engagement with both coupling wheels 166, and each coupling wheel 166 is in engagement with the rotary body 44.

The holding body 78 has a one-piece holding ring 168 which corresponds in form and function to the holding ring 80 together with the fixing ring 82 in the case of the washing brush 14.

The holding element 136 of the restoring devices 122 and 124 is formed by the support tube 32 itself in the case of the washing brush 160. The receptacles 140 are perforations in the wall 36. The end section 142 of the torsional spring 130 engages radially into one of the through-openings. A separate holding element may be saved.

In the washing brush 160, the stop element 152 is formed as one piece with the holding ring 168 and is molded onto the same, for example.

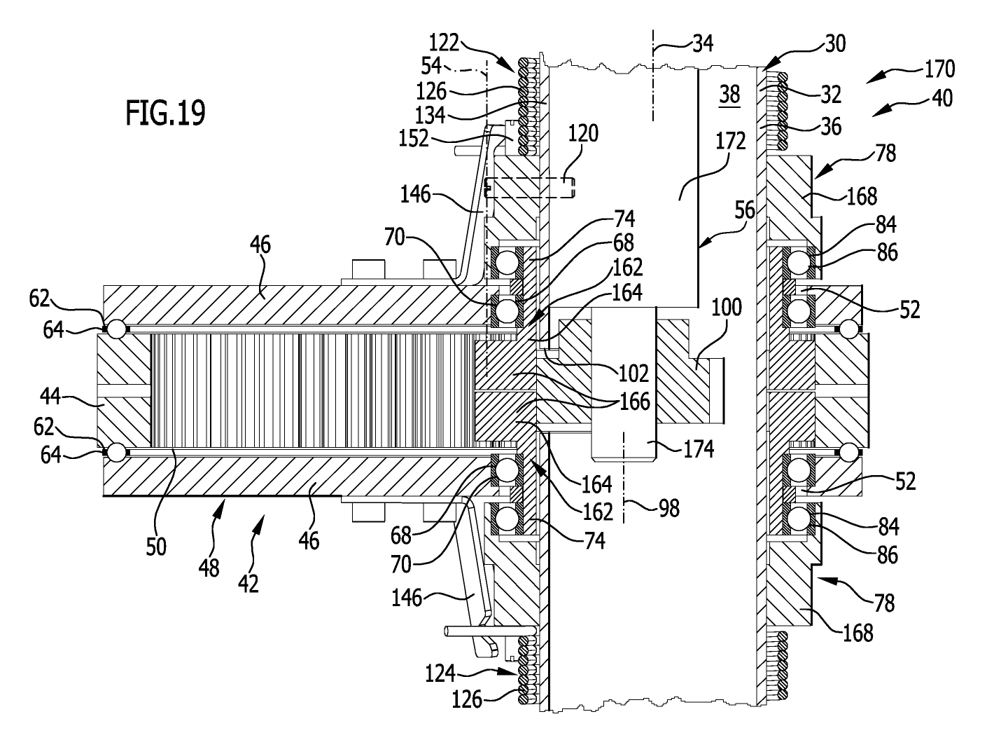

FIG. 19 shows a partial depiction of a brush segment 40 of a washing brush designated with the reference numeral 170.

In the washing brush 170, the drive device 56 has a plurality of drive motors 172. A drive shaft 174 is driven eccentrically to the pivotal axis 34 by way of the drive motor 172. The drive wheel 110 is non-rotatably held onto the drive shaft 174. By using different drive motors 172, the drive motor 94, the drive shaft 96, and the bearing bushes 116 may be omitted.

A drive motor 172 is associated with each brush segment 40 and the rotary body thereof 44. This allows for individually driving the rotary bodies 44, in particular at different rotational speeds and/or in different rotational directions. It is thereby possible, for example, to optimize the cleaning of the vehicle 12 at a certain vehicle region by means of the brush segment 40 contacting the vehicle region.

For example, provision is made for lower vehicle regions to be cleaned at higher speed and higher intensity under rotation of the rotary body 44, because these vehicle regions are typically more heavily soiled. Vehicle regions at the top of the vehicle, for example near the roof, may, for example, be cleaned at a lower rotational speed of the rotary body 44 and with reduced cleaning intensity.

The drive motor 172 is arranged in the inner space 38 in the case of the washing brush 170. The drive motor 172 is preferably fixed by way of fixing elements guided from the outside through the wall 36. Preferably used in this case are the fixing elements 120 that also fix the holding body 78 on the support tube 32.

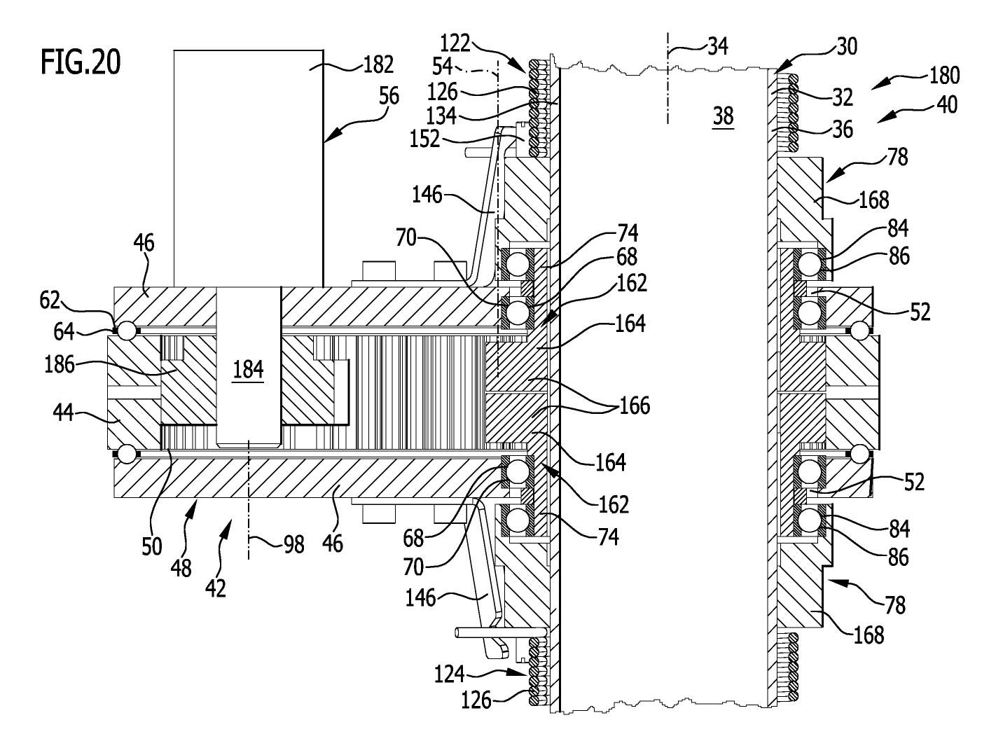

FIG. 20 shows a partial depiction of a brush segment 40 of a washing brush designated with the reference numeral 180.

Drive motors 182 are also provided in the case of the washing brush 180, wherein a drive motor 182 is associated with each brush segment 40. The drive motor 94, the drive shaft 96, and the bearing bushes 116 may be omitted.

The drive motors 182 are secured on the respective housing 48 in the case of the washing brush 180. For example, the drive motor 182 is connected to a pivotal body 46 by a screw connection not shown in the illustration. The drive motor 182 is advantageously located at the top on the housing 48.

A drive shaft 184 engages into the inner space 50. The drive shaft 184 is aligned in parallel to the rotational axis 54. A drive wheel 186 in the inner space 50 is non-rotatably held on the drive shaft 184. The drive wheel 186 is in engagement with the inside of the rotary body 44. A tooth arrangement is advantageously provided between the drive wheel 186 and the rotary body 44.

In the washing brush 180, in place of the coupling wheel 104 or the coupling wheels 166, a guide wheel 188 is used. The outside of the guide wheel 188 is in engagement with the rotary body 44, for example by way of a tooth arrangement. Because the drive wheel 100 is omitted, an engagement on the guide wheel 188 on the inside in not necessary. The through-opening 102 in the wall 36 may be omitted.

As a result of the separate drive motors 182 in case of the washing brush 180, the additional advantages already mentioned in conjunction with the washing brush 170 may likewise be achieved, which result from individually driving each rotary body 44.

It is understood that the different variants for the bearing body 66 and the bearing bodies 162, respectively, may selectively be used in all embodiments of the washing brush that are described here. The same applies to the different variants of the holding body 78 with separate holding ring 80 and fixing ring 82 or the holding ring 168. Furthermore, the same applies to the holding element 136 of the restoring devices 122, 124 as a clamping ring 138 or formed by the support tube 32.

### REFERENCE NUMERAL LIST

10 gantry-type washing installation
12 vehicle
14 vehicle washing brush
16 side brush
18 lateral vehicle surface
20 supporting surface
22 vertical support
24 transverse support
26 actuator
28 transverse direction (arrow)
30 support part
32 support tube
34 pivotal axis
36 wall
38 inner space
40 brush segment
42 pivoting device
44 rotary body
46 pivotal body
48 housing
50 inner space
52 through-opening
54 rotational axis
56 drive device
58 cleaning element
60 holding body
62 bearing element
64 bearing ring
66 bearing body
68 bearing element
70 bearing ring
72 bearing sleeve
74 sleeve section
76 middle section
78 holding body
80 holding ring
82 fixing ring
84 bearing element
86 bearing ring
88 shoulder
90 intermediate ring
92 shoulder
94 drive motor
96 drive shaft
96 drive axis
100 drive wheel
102 through-opening
104 coupling wheel
106 pivot direction (arrow)
108 pivot direction (arrow)
110 line (contour)
112 rotational direction (arrow)
114 rotational direction (arrow)
116 bearing bush
118 bearing ring
120 fixing element
122 restoring device
124 restoring device
126 restoring element
128 spring element
130 torsional spring
132 winding
134 core
136 holding element
138 clamping ring
140 receptacle
142 end section
144 end section
146 stop element
148 stop angle bracket
150 recess
152 stop element
154 stop pin
160 washing brush
162 bearing body
164 bearing sleeve
166 coupling wheel
168 holding ring
170 washing brush
172 drive motor
174 drive shaft
180 washing brush
182 drive motor
184 drive shaft
186 drive wheel
188 guide wheel

1. A vehicle treatment brush for washing or polishing purposes in a vehicle treatment installation, comprising:
a support part having a longitudinal extent and defining a pivotal axis,
a plurality of brush segments arranged axially next to each other and each comprising cleaning elements, and
a drive device,
wherein at least one brush segment comprises a pivoting device with a rotary body on which the cleaning elements of the brush segment are indirectly or directly held and which is in operative connection with the drive device for driving the rotary body about a rotational axis of the brush segment that is different from the pivotal axis,
wherein the rotary body is pivotable about the pivot axis relative to the support part by way of the pivoting device,
wherein the brush segment comprises at least one restoring device with a restoring element, against the action of which the pivoting device is pivotable relative to the support part in a pivot direction,
wherein the restoring element comprises or forms a torsional spring which couples to the pivoting device on the one hand and to a stationary holding element on the other hand for pivoting the pivoting device and the holding element relative to each other.

2. The vehicle treatment brush in accordance with claim 1, wherein the torsional spring is configured as a coil spring.

3. The vehicle treatment brush in accordance with claim 1, wherein a core is provided which the torsional spring surrounds.

4. The vehicle treatment brush in accordance with claim 3, wherein the support part comprises or forms the core.

5. The vehicle treatment brush in accordance with claim 1, wherein the torsional spring is aligned coaxially to the support part.

6. The vehicle treatment brush in accordance with claim 1, wherein the support part forms the holding element or wherein the holding element is secured on the support part.

7. The vehicle treatment brush in accordance with claim 1, wherein the torsional spring is arranged within a contour of the rotary body independently of the position of the pivoting device relative to the support part.

8. The vehicle treatment brush in accordance with claim 1, wherein the pivoting device is pivotable in the pivot direction relative to the support part commencing from a base position against a pretension of the torsional spring.

9. The vehicle treatment brush in accordance with claim 8, wherein the pretension of the torsional spring is variable.

10. The vehicle treatment brush in accordance with claim 9, wherein the holding element comprises or forms a plurality of receptacles into which the torsional spring may selectively engage and thereby may be brought into different tensioned states.

11. The vehicle treatment brush in accordance with claim 1, wherein the rotary body is pivotable in two opposite pivot directions by way of the pivoting device.

12. The vehicle treatment brush in accordance with claim 1, wherein the restoring device comprises a stop element for the torsional spring against which the latter strikes when the pivoting device adopts a base position in such a way that no spring force is exerted on the pivoting device by way of the spring element in the base position, and wherein the pivoting device is pivotable in the opposite pivot direction commencing from the base position.

13. The vehicle treatment brush in accordance with claim 1, wherein the brush segment comprises two restoring devices, wherein the rotary body is pivotable relative to the support part in two opposite pivot directions by way of the pivoting device, against the action of a respective restoring element of a restoring device.

14. The vehicle treatment brush in accordance with claim 13, wherein the restoring devices are arranged axially on mutually opposite sides of the pivoting device.

15. The vehicle treatment brush in accordance with claim 13, wherein both restoring elements are configured as torsional springs which couple to the pivoting device at one end and to a respective stationary holding element at the other end.

16. The vehicle treatment brush in accordance with claim 15, wherein the torques which are exertable on the pivoting device by the torsional springs are opposed to each other.

17. The vehicle treatment brush in accordance with claim 15, wherein the restoring device comprises a stop element for the torsional spring against which the latter strikes when the pivoting device adopts a base position in such a way that no spring force is exerted on the pivoting device by way of the spring element in the base position, wherein the pivoting device is pivotable in the opposite pivot direction commencing from the base position, and wherein the torsional springs strike against respective stop elements when the pivoting device adopts the base position.

18. The vehicle treatment brush in accordance with claim 15, wherein the pivoting device in the base position is free of restoring forces and torques, respectively, exertable by way of the torsional springs.

19. The vehicle treatment brush in accordance with claim 1, wherein two or more brush segments comprise a pivoting device with a rotary body, wherein the rotary bodies are pivotable independently of each other about the pivotal axis relative to the support part by way of the respective pivoting device.

20. The vehicle treatment brush in accordance with claim 19, wherein the drive device comprises a plurality of drive motors, and wherein a drive motor is associated with each brush segment for driving the respective rotary body.

21. The vehicle treatment brush in accordance with claim 1, wherein a respective brush segment comprises at least one restoring device.

22. The vehicle treatment brush in accordance with claim 1, wherein the support part is non-driven.

23. The vehicle treatment brush in accordance with claim 1, wherein the rotary bodies of two or more brush segments are drivable by means of a drive motor of the drive device.

24. The vehicle treatment brush in accordance with claim 1, wherein the pivoting device comprises at least one pivotal body which is pivotable about the pivotal axis and relative to which the rotary body is configured to be rotational, wherein the at least one pivotal body is coupled to the rotary body and the restoring force of the torsional spring engages on the at least one pivotal body.

25. The vehicle treatment brush in accordance with claim 1, wherein the vehicle treatment brush is a side brush or a roof brush.

26. The vehicle treatment brush in accordance with claim 1, wherein the cleaning elements are bristles, washing strips, or polishing strips.

27. A vehicle treatment installation, comprising:
at least one vehicle treatment brush, the vehicle treatment brush comprising a support part having a longitudinal extent and defining a pivotal axis,
a plurality of brush segments arranged axially next to each other and each comprising cleaning elements, and
a drive device,
wherein at least one brush segment comprises a pivoting device with a rotary body on which the cleaning elements of the brush segment are indirectly or directly held and which is in operative connection with the drive device for driving the rotary body about a rotational axis of the brush segment that is different from the pivotal axis,
wherein the rotary body is pivotable about the pivot axis relative to the support part by way of the pivoting device,
wherein the brush segment comprises at least one restoring device with a restoring element, against the action of which the pivoting device is pivotable relative to the support part in a pivot direction,
wherein the restoring element comprises or forms a torsional spring which couples to the pivoting device on the one hand and to a stationary holding element on the other hand for pivoting the pivoting device and the holding element relative to each other.
